(19) United States
(12) Patent Application Publication
(10) Pub. No.: US 2024/0283508 A1
(43) Pub. Date: Aug. 22, 2024

(54) Method And Apparatus For Estimating CSI Processing Unit In Mobile Communications

(71) Applicant: MediaTek Inc., Hsinchu City (TW)

(72) Inventor: Chi-Hsuan Hsieh, Hsinchu City (TW)

(21) Appl. No.: 18/420,835

(22) Filed: Jan. 24, 2024

Related U.S. Application Data
(60) Provisional application No. 63/485,935, filed on Feb. 20, 2023.

(51) Int. Cl. H04B 7/06; H04W 72/1273; H04W 72/232

(52) U.S. Cl. CPC H04B 7/0626; H04B 7/0632; H04W 72/1273; H04W 72/232

(57) ABSTRACT

Examples pertaining to determination of occupied channel state information (CSI) processing units in mobile communications are described. A user equipment (UE) receives a report configuration from a network apparatus. The report configuration contains one or more sub-configurations. Then, the UE performs determines a number of occupied CSI processing units based on a total number of resources corresponding to at least one of the sub-configurations and a scaling number.

### CROSS REFERENCE TO RELATED PATENT APPLICATION(S)

The present disclosure is part of a non-provisional application claiming the priority benefit of U.S. Patent Application No. 63/485,935, filed 20 Feb. 2023, the content of which herein being incorporated by reference in its entirety.

### TECHNICAL FIELD

The present disclosure is generally related to mobile communications and, more particularly, to estimation of channel state information (CSI) processing unit with respect to user equipment and network apparatus in mobile communications.

### BACKGROUND

Unless otherwise indicated herein, approaches described in this section are not prior art to the claims listed below and are not admitted as prior art by inclusion in this section.

The fifth-generation (5G) network, despite its enhanced energy efficiency in bits per Joule (e.g., 417% more efficiency than a 4G network) due to its larger bandwidth and better spatial multiplexing capabilities, may consume over 140% more energy than a 4G network.

Considering of this, how to achieve network energy saving becomes an important issue for the newly developed wireless communication network. However, in order to support network energy saving, some extra efforts, such as extra computations in signal processing, at the user equipment (UE) side will be inevitably increased. The extra efforts can be made by the UE may be limited to the UE capability.

To reflect the actual condition of UE capability, there is a need to provide proper schemes for accurate estimation for the UE capability.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to accurate determination or estimation of the capability of a communication apparatus (e.g., a UE) in mobile communications.

In one aspect, a method may involve a communication apparatus receiving a report configuration containing one or more sub-configurations from a network apparatus and determining a number of occupied CSI processing units based on a total number of resources corresponding to at least one of the sub-configurations and a scaling number.

In one aspect, a communication apparatus may involve a transceiver which, during operation, wirelessly communicates with at least one network apparatus. The communication apparatus may also involve a processor communicatively coupled to the transceiver such that, during operation, the processor performs following operations: receiving, via the transceiver, a report configuration from the network apparatus, wherein the report configuration contains one or more sub-configurations; and determining a number of occupied CSI processing units based on a total number of resources corresponding to at least one of the sub-configurations and a scaling number.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of 32 ports CSI-RS resource configuration under schemes in accordance with implementations of the present disclosure.

FIG. 2 is a diagram depicting an example scenario of type 1 spatial domain adaptation under schemes in accordance with implementations of the present disclosure.

FIG. 3 is a diagram depicting an example scenario of several power offsets under schemes in accordance with implementations of the present disclosure.

FIG. 4 is a diagram depicting an example scenario of a CSI report configuration message flow under schemes in accordance with implementations of the present disclosure.

FIG. 5 is a diagram depicting an example communication system having an example communication apparatus and an example network apparatus in accordance with an implementation of the present disclosure.

FIG. 6 is a diagram depicting an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to accurate determination or estimation of factors related to UE capability, such as the UE computing efforts. In some implementations, the UE computing efforts may be the CSI computing efforts, which may also be named as the CSI processing units (CPUs). According to the present disclosure, a number of possible solutions may be implemented separately or jointly. That is, although these possible solutions may be described below separately, two or more of these possible solutions may be implemented in one combination or another.

To achieve network energy saving (or network power saving) in mobile communications, a network apparatus (e.g., a network node or a base station (BS), such as a next generation Node B (gNB)) may perform adaptation in spatial domain and/or power domain.

When performing spatial domain (SD) adaptation (which may also be named as spatial element adaptation, antenna element adaptation or antenna port adaptation), the network apparatus with an antenna architecture having a plurality of physical antennas may mute or unmute (e.g., enable or disable) one or more physical antennas or one or more antenna ports. The physical antennas of the network apparatus may associate with one or more logical antenna ports.

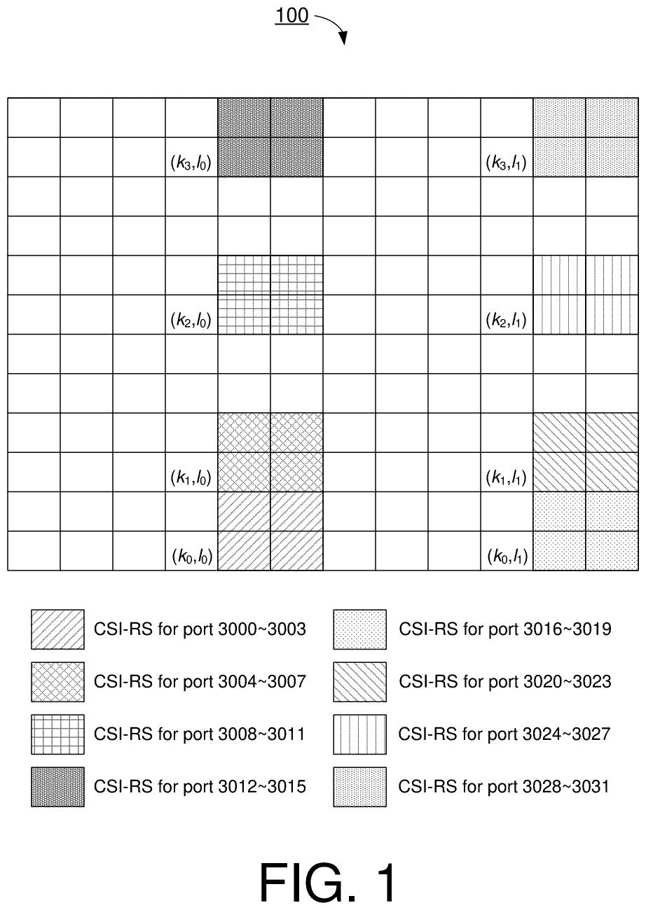

FIG. 1 illustrates an example scenario 100 of 32 ports CSI reference signal (CSI-RS) resource configuration under schemes in accordance with implementations of the present disclosure. In an event that the SD adaptation is not performed, the 32 antenna ports configured for the CSI-RS resource may all be enabled. In an event that the SD adaptation is performed, the number of enabled antenna ports will be reduced (e.g., by disabling or muting one or more antenna ports).

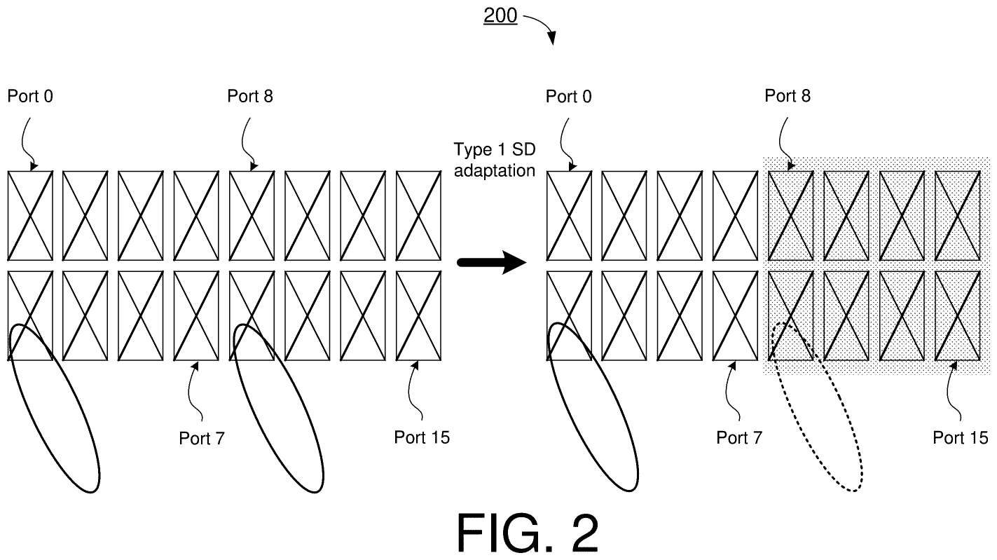

FIG. 2 illustrates an example scenario 200 of type 1 SD adaptation under schemes in accordance with implementations of the present disclosure. In FIG. 2, a port muting pattern (or a spatial adaptation pattern) with antenna ports 8-15 being disabled (muted) is shown, and an antenna port subset may be associated with the port muting pattern. In this embodiment, the status of the antenna ports 0-7 are enabled, and the status of the antenna ports 8-15 are changed from an enabled status to a disabled status after the SD adaptation is applied, for implementing network energy saving in spatial domain.

In some implementations, the network apparatus may determine an enabled or disabled status of the antenna ports (e.g., determine the corresponding port muting pattern) for one or more antenna port subsets and transmit a report configuration (e.g., a radio resource control (RRC) configuration, such as an RRC configuration CSI-ReportConfig) to the communication apparatus. The report configuration may comprise one or more sub-configurations associating with the one or more antenna port subsets, such as a list of sub-configurations associating with the one or more antenna port subsets and provided by a higher layer parameter.

In some implementations, one report configuration may contain multiple CSI report sub-configurations. Each sub-configuration may be identified by a sub-configuration ID and may correspond to at least one antenna port subset (e.g., correspond to at least one spatial adaptation pattern or at least one port muting pattern, or correspond to one or more CSI-RS resources).

The communication apparatus may receive the report configuration containing said one or more sub-configurations from the network apparatus and transmit at least one measurement report based on the report configuration. In some implementations, the communication apparatus may measure the CSI-RS based on the report configuration. In some implementations, the measuring of the CSI-RS associated with one or more disabled antenna ports is not performed. The communication apparatus may generate the measurement report according to a result of the measuring of the CSI-RS.

For another aspect, when performing power domain adaptation, the network apparatus may configure multiple power offset values with respect to at least one power offset parameter, for the communication apparatus to provide one or more measurement reports based on the power offset values.

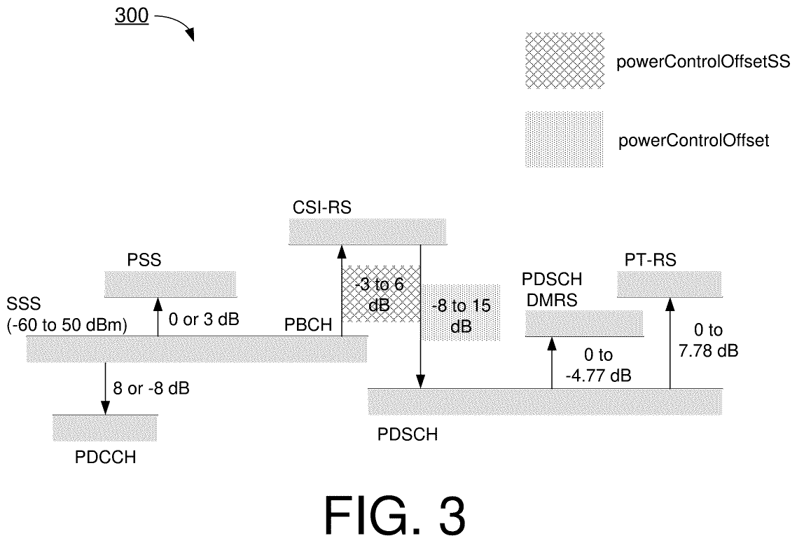

FIG. 3 illustrates an example scenario 300 of different power offsets under schemes in accordance with implementations of the present disclosure. The network apparatus may determine the downlink transmit power, e.g., the energy per resource element (EPRE), for the communication apparatus. The network apparatus may first indicate the downlink transmit power of synchronization signal (SS) and physical broadcast channel (PBCH) block (i.e., SSB) in a master information block (MIB) or a system information block (SIB).

The communication apparatus may derive the downlink CSI-RS EPRE from the SS/PBCH block downlink transmit power and CSI-RS power offset given by the power offset parameter powerControlOffsetSS provided by higher layers. Referring to FIG. 3, the power offset parameter powerContolOffsetSS may indicate a value in the range of [−3, 6] dB. The power offset parameter powerContolOffset is the assumed ratio of physical downlink shared channel (PDSCH) EPRE to non-zero power (NZP) CSI-RS EPRE when communication apparatus derives CSI feedback and may indicate a value in the range of [−8, 15] dB.

In some embodiments, the network apparatus may determine one or more power offset values for the communication apparatus and transmit a report configuration (e.g., the RRC configuration CSI-ReportConfig) to the communication apparatus. The report configuration may comprise one or more sub-configurations associating with the one or more power offset values, such as a list of sub-configurations associating with the one or more power offset values and provided by a higher layer parameter.

In some implementations, one report configuration may contain multiple CSI report sub-configurations. Each sub-configuration may be identified by a sub-configuration ID and may correspond to at least one power offset value, and the power offset values may be the configurable values of a predetermined power offset. As an example, but not limited to, the predetermined power offset may be the aforementioned power offset parameters powerContolOffset or powerContolOffsetSS.

In some embodiments, multiple values of power offset parameter powerContolOffset or powerContolOffsetSS (e.g., multiple powerContolOffset or multiple powerContolOffsetSS) may be configured, and the list of sub-configurations indicated in the report configuration may be an implementation of configuring multiple powerContolOffset or powerContolOffsetSS.

The communication apparatus may receive the report configuration containing said one or more sub-configurations from the network apparatus and transmit at least one measurement report based on the report configuration. In some implementations, the communication apparatus may measure the CSI-RS to determine one or more CSI parameters, such as the channel quality indicator (CQI), based on at least one of the power offset values. The communication apparatus may generate one or more measurement reports according to the one or more CSI parameters, to report the CSI parameters to the network apparatus as the CSI feedback. With the CSI feedback, the network apparatus may determine a proper downlink power, which may have a reduced power consumption, for implementing network energy saving in power domain.

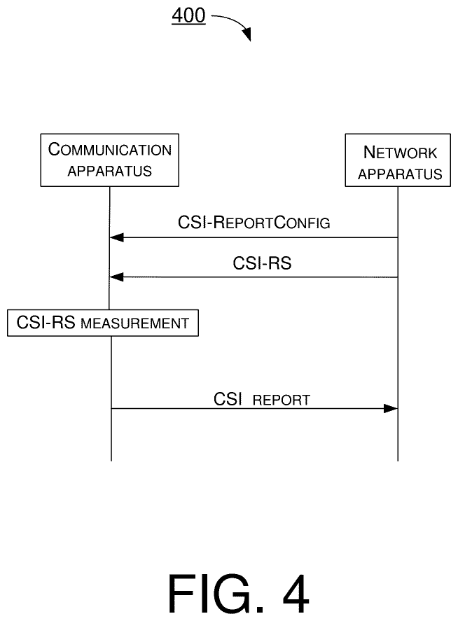

FIG. 4 illustrates an example scenario 400 of a CSI report configuration message flow under schemes in accordance with implementations of the present disclosure. Scenario 400 involves a communication apparatus (e.g., a UE) and a network apparatus transmitting messages therebetween. Referring to FIG. 4, the UE may receive a CSI report (re)configuration (e.g., the CSI-ReportConfig) from the network apparatus through RRC.

In some embodiments, the CSI report (re)configuration CSI-ReportConfig may contain a list of sub-configurations associating with one or more antenna port subsets or a list of sub-configurations associating with one or more power offset values. In some embodiments, the communication apparatus may further receive an indication to select a predetermined number of the sub-configurations from the network apparatus via a downlink control information (DCI) or a media access control (MAC) control element (MAC-CE). The predetermined number of the sub-configurations is selected from said one or more sub-configurations contained in the report configuration.

After the CSI report (re)configuration has been applied, the UE may receive the CSI-RS at the CSI-RS occasion(s) to perform the CSI-RS measurement, as an example, for the predetermined number of the sub-configurations indicated via DCI or MAC-CE, and accordingly determine one or more CSI parameters. The UE may report one or more measurement report based on the one or more CSI parameters.

In some embodiments, the network apparatus may perform adaptation in power domain as described above according to said one or more measurement reports generated by the UE based on the power offset values.

In some embodiments, in an event that the predetermined number of the sub-configurations selected by the network apparatus are associated with one or more antenna port subsets (i.e., one or more port muting patterns), the network apparatus may also perform the same or different spatial domain adaptation according to said one or more measurement reports generated by the UE.

In some embodiments, in an event that the communication apparatus provides the CSI feedback for different port muting patterns or different power offset values based on one CSI-RS resource configuration, the computing efforts at the communication apparatus side (i.e., the UE side) for one CSI-RS resource is increased. Note that in the embodiments, the computing effort is one of the factors related to the UE capability, and the computing effort may be the CSI computing efforts or the CPUs (i.e., the CSI processing units). To accurately determine or estimate the factors related to UE capability, such as the aforementioned CSI computing efforts or CPUs, counting scaling of CSI-RS resource for multiple sub-configurations, multiple CSI measurements or multiple CSI reports is introduced.

In some embodiments, utilization of one or more scaling number(s) on the CSI-RS resource is introduced to reflect the increased computing efforts (i.e., the increased CPUs).

In some embodiments, the communication apparatus may receive a report configuration comprising or containing one or more sub-configurations from the network apparatus and estimate or determine a number of occupied CSI processing units based on a total number of resources corresponding to at least one of the sub-configurations and a scaling number.

In some embodiments, the scaling number is greater than 1.

In some embodiments, said at least one of the sub-configurations corresponds to an antenna port subset which indicates one or more enabled or disabled antenna ports of a plurality of antenna ports of the network apparatus.

In some embodiments, said at least one of the sub-configurations corresponds to one or more power offset values configured for the communication apparatus to determine the CQI. The communication apparatus may determine the CQI according to at least one of said one or more power offset values.

In some embodiments, said one or more power offset values comprise a power offset for a PDSCH relative to the CSI-RS.

In some embodiments, when estimating or determining the number of occupied CSI processing units, the communication apparatus may scale up the number of occupied CSI processing units with respect to one resource associated with more than one sub-configuration according to the scaling number.

In some embodiments, the communication apparatus may receive an indication to select a predetermined number of the sub-configurations from the network apparatus via a DCI or a MAC-CE, wherein the predetermined number of the sub-configurations is selected from said one or more sub-configurations contained in the report configuration, and the scaling number may be set to the predetermined number. In some embodiments, when estimating or determining the number of occupied CSI processing units, the communication apparatus may accumulate the total number of resources corresponding to each of the predetermined number of the sub-configurations.

As an example, suppose that L sub-configurations is contained in the report configuration and the predetermined number is N, where L and N are positive integers, N≤L and N≥1.

In some embodiments, if a report configuration (e.g., the RRC configuration CSI-ReportConfig) contains a list of L sub-configurations provided by the higher layer parameter, for aperiodic and semi-persistent CSI reporting, the communication apparatus may accumulate the total number of resources corresponding to each of the predetermined number of the sub-configurations as the following equation:

$${O}_{CPU} = {\sum }_{i = 1}^{N} {K}_{s}^{i} \qquad Eq . ( 1 )$$

where Kₛⁱ is the total number of CSI-RS resources corresponding to the i-th sub-configuration, and where the i-th sub-configuration is from the N indicated sub-configurations out of the L sub-configurations contained in the configuration CSI-ReportConfig.

In some embodiments, for one resource (e.g., one CSI-RS resource, such as a NZP CSI-RS resource) configured with multiple sub-configurations, multiple CSI measurements or multiple CSI reports based on different port muting patterns or different power offset values, the scaling number may be set to a value of α or β, to reflect the increased CPUs (i.e., the CSI computing efforts of the communication apparatus), where α>1 and β>1. Some exemplary implementations are given below.

In some embodiments with respect to multiple configured port muting patterns, when estimating or determining the number of occupied CSI processing units, one CSI-RS resource configured with multiple sub-configurations, multiple CSI measurements or multiple CSI reports based on different port muting patterns may be counting as α (α>1) CSI-RS resources.

In some embodiments with respect to multiple configured power offset values, when estimating or determining the number of occupied CSI processing units, one CSI-RS resource configured with multiple sub-configurations, multiple CSI measurements or multiple CSI reports based on different power offset values may be counting as β (β>1) CSI-RS resources.

In some embodiments, the communication apparatus may transmit information regarding the number of occupied CSI processing units (e.g., the estimated or determined O_{CPU}, or the counting scaled a CSI-RS resources or βCSI-RS resources) to the network apparatus.

In some embodiments, the communication apparatus may measure the CSI-RS based on the predetermined number of the sub-configurations indicated via the DCI or the MAC-CE.

In some embodiments, for a CSI report configuration containing sub-configuration(s) indicated in the report configuration, such as a CSI-ReportConfig, if a CSI-RS resource is referred by M sub-configurations among X sub-configurations, the CSI-RS resource is counted M times and the CSI-RS ports within the CSI-RS resource are counted as the follows:
max(Σₛ₌₁^{M}Pₛ, P) if each sub-configuration, of the M sub-configurations, is configured with a CSI-RS antenna port subset, or
M×P if each sub-configuration, of the M sub-configurations, is configured with a list of one or more CSI-RS resources or is configured with a power offset,
where M, P, s and Pₛ are positive integers, P is the number of ports and Pₛ is the number of CSI-RS ports in sub-configuration s derived from the corresponding antenna port subset indicator.

### Illustrative Implementations

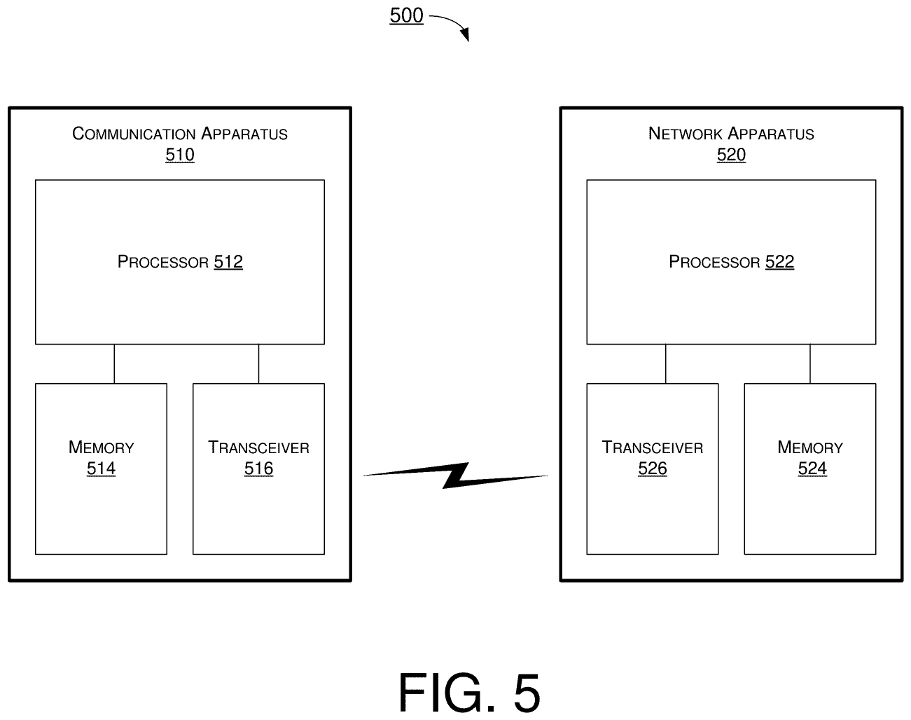

FIG. 5 illustrates an example communication system 500 having an example communication apparatus 510 and an example network apparatus 520 in accordance with an implementation of the present disclosure. Each of the communication apparatus 510 and the network apparatus 520 may perform various functions to implement schemes, techniques, processes and methods described herein pertaining to determination or estimation of occupied CPU with respect to the communication apparatus and the network apparatus supporting one CSI-RS resource configured with one or more sub-configurations in mobile communications, including scenarios/schemes described above as well as the process 600 described below.

Communication apparatus 510 may be a part of an electronic apparatus, which may be a UE such as a portable or mobile apparatus, a wearable apparatus, a wireless communication apparatus or a computing apparatus. For instance, the communication apparatus 510 may be implemented in a smartphone, a smartwatch, a personal digital assistant, a digital camera, or a computing equipment such as a tablet computer, a laptop computer or a notebook computer. The communication apparatus 510 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 510 may be implemented in a smart thermostat, a smart fridge, a smart door lock, a wireless speaker or a home control center. Alternatively, the communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. The communication apparatus 510 may include at least some of those components shown in FIG. 5 such as a processor 512, for example. The communication apparatus 510 may further include one or more other components not pertinent to the proposed scheme of the present disclosure (e.g., internal power supply, display device and/or user interface device), and, thus, such component(s) of the communication apparatus 510 are neither shown in FIG. 5 nor described below in the interest of simplicity and brevity.

The network apparatus 520 may be a part of a network device, which may be a network node such as a satellite, a base station, a small cell, a router or a gateway. For instance, the network apparatus 520 may be implemented in an eNodeB in an LTE network, in a gNB in a 5G/NR, IoT, NB-IoT or IIoT network or in a satellite or base station in a 6G network. Alternatively, network apparatus 520 may be implemented in the form of one or more IC chips such as, for example and without limitation, one or more single-core processors, one or more multi-core processors, or one or more RISC or CISC processors. The network apparatus 520 may include at least some of those components shown in FIG. 5 such as a processor 522, for example. The network apparatus 520 may further include one or more other components not pertinent to the proposed scheme of the present disclosure (e.g., internal power supply, display device and/or user interface device), and, thus, such component(s) of the network apparatus 520 are neither shown in FIG. 5 nor described below in the interest of simplicity and brevity.

In one aspect, each of the processor 512 and the processor 522 may be implemented in the form of one or more single-core processors, one or more multi-core processors, or one or more CISC processors. That is, even though a singular term “a processor” is used herein to refer to the processor 512 and the processor 522, each of the processor 512 and the processor 522 may include multiple processors in some implementations and a single processor in other implementations in accordance with the present disclosure. In another aspect, each of the processor 512 and the processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 512 and the processor 522 is a special-purpose machine specifically designed, arranged and configured to perform specific tasks including autonomous reliability enhancements in a device (e.g., as represented by communication apparatus 510) and a network (e.g., as represented by network apparatus 520) in accordance with various implementations of the present disclosure.

In some implementations, the communication apparatus 510 may also include a transceiver 516 coupled to the processor 512 and capable of wirelessly transmitting and receiving data. In some implementations, the communication apparatus 510 may further include a memory 514 coupled to the processor 512 and capable of being accessed by the processor 512 and storing data therein. In some implementations, the network apparatus 520 may also include a transceiver 526 coupled to the processor 522 and capable of wirelessly transmitting and receiving data. In some implementations, the network apparatus 520 may have a plurality of physical antennas which associates with a plurality of antenna ports. In some implementations, the network apparatus 520 may further include a memory 524 coupled to processor 522 and capable of being accessed by the processor 522 and storing data therein. Accordingly, communication apparatus 510 and the network apparatus 520 may wirelessly communicate with each other via the transceiver 516 and the transceiver 526, respectively. To aid better understanding, the following description of the operations, functionalities and capabilities of each of the communication apparatus 510 and the network apparatus 520 is provided in the context of a mobile communication environment in which the communication apparatus 510 is implemented in or as a communication apparatus or a UE and the network apparatus 520 is implemented in or as a network node or a network device of a communication network.

In some implementations, the processor 512 of the communication apparatus 510 may receive a report configuration from the network apparatus 520 via the transceiver 516. The report configuration may comprise or contain one or more sub-configurations. In some implementations, processor 512 may estimate or determine a number of occupied CSI processing units (i.e., the CPUs) based on a total number of resources corresponding to at least one of the sub-configurations and a scaling number. In some implementations, the scaling number is greater than 1.

In some implementations, in estimating or determining the number of occupied CSI processing units, the processor 512 may scale up the number of occupied CSI processing units with respect to one resource associated with more than one sub-configuration according to the scaling number.

In some implementations, the processor 512 may receive, via the transceiver 516, an indication to select a predetermined number of the sub-configurations from the network apparatus 520 via a DCI or MAC-CE, wherein the predetermined number of the sub-configurations is selected from said one or more sub-configurations contained in the report configuration.

In some implementations, the scaling number is set to the predetermined number, and in estimating or determining the number of occupied CSI processing units, the processor 512 may accumulate the total number of resources corresponding to each of the predetermined number of the sub-configurations, such as the equation Eq. (1) introduced above.

In some implementations, processor 512 may measure a CSI-RS based on the predetermined number of the sub-configurations.

In some implementations, processor 512 may transmit, via the transceiver 516, information regarding the number of occupied CSI processing units to the network apparatus 520.

In some implementations, said at least one of the sub-configurations corresponds to an antenna port subset which indicates one or more enabled or disabled antenna ports of a plurality of antenna ports of the network apparatus.

In some implementations, said at least one of the sub-configurations corresponds to one or more power offset values. The processor 512 may determine a CQI according to at least one of said one or more power offset values.

In some implementations, said one or more power offset values comprise a power offset for the PDSCH relative to the CSI-RS.

### Illustrative Processes

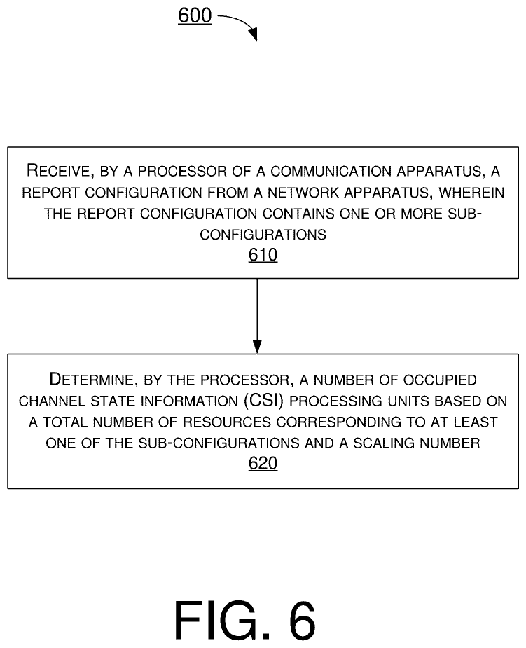

FIG. 6 illustrates an example process 600 in accordance with an implementation of the present disclosure. The process 600 may be an example implementation of above scenarios/schemes, whether partially or completely, with respect to accurate determination or estimation of occupied CPU with the present disclosure. Process 600 may represent an aspect of implementation of features of the communication apparatus 510. The process 600 may include one or more operations, actions, or functions as illustrated by one or more of blocks 610 and 620. Although illustrated as discrete blocks, various blocks of the process 600 may be divided into additional blocks, combined into fewer blocks, or eliminated, depending on the desired implementation. Moreover, the blocks of the process 600 may be executed in the order shown in FIG. 6 or, alternatively, in a different order. The process 600 may be implemented by the communication apparatus 510 or any suitable UE or machine type devices. Solely for illustrative purposes and without limitation, process 600 is described below in the context of the communication apparatus 510. The process 600 may begin at block 610.

At 610, process 600 may involve the processor 512 of the communication apparatus 510 receiving report configuration from a network apparatus, such as the network apparatus 520. The report configuration comprises or contains one or more sub-configurations. The process 600 may proceed from 610 to 620.

At 620, the process 600 may involve processor 512 determining a number of occupied CSI processing units (i.e., the CPUs) based on a total number of resources corresponding to at least one of the sub-configurations and a scaling number.

In some implementations, the scaling number is greater than 1.

In some implementations, the process 600 may involve the processor 512 scaling up the number of occupied CSI processing units with respect to one resource associated with more than one sub-configuration according to the scaling number.

In some implementations, the process 600 may involve the processor 512 receiving an indication to select a predetermined number of the sub-configurations from the network apparatus 520 via a DCI or MAC-CE, wherein the predetermined number of the sub-configurations is selected from said one or more sub-configurations contained in the report configuration.

In some implementations, the scaling number is set to the predetermined number, and the process 600 may involve the processor 512 accumulating the total number of resources corresponding to each of the predetermined number of the sub-configurations, such as the equation Eq. (1) introduced above.

In some implementations, process 600 may involve the processor 512 measuring a CSI-RS based on the predetermined number of the sub-configurations.

In some implementations, process 600 may involve the processor 512 transmitting information regarding the number of occupied CSI processing units to the network apparatus 520.

In some implementations, said at least one of the sub-configurations corresponds to an antenna port subset which indicates one or more enabled or disabled antenna ports of a plurality of antenna ports of the network apparatus.

In some implementations, said at least one of the sub-configurations corresponds to one or more power offset values. In some implementations, process 600 may involve the processor 512 determining a CQI according to at least one of said one or more power offset values.

In some implementations, said one or more power offset values comprise a power offset for the PDSCH relative to the CSI-RS.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of a communication apparatus, a report configuration from a network apparatus, wherein the report configuration contains one or more sub-configurations; and
determining, by the processor, a number of occupied channel state information (CSI) processing units based on a total number of resources corresponding to at least one of the sub-configurations and a scaling number.

2. The method of claim 1, wherein the scaling number is greater than 1.

3. The method of claim 2, wherein the determining of the number of occupied CSI processing units further comprises:
scaling up the number of occupied CSI processing units with respect to one resource associated with more than one sub-configuration according to the scaling number.

4. The method of claim 1, further comprising:
receiving, by the processor, an indication to select a predetermined number of the sub-configurations from the network apparatus via a downlink control information (DCI) or a media access control (MAC) control element (MAC-CE), wherein the predetermined number of the sub-configurations is selected from said one or more sub-configurations contained in the report configuration.

5. The method of claim 4, wherein the scaling number is set to the predetermined number, and the determining of the number of occupied CSI processing units further comprises:
accumulating, by the processor, the total number of resources corresponding to each of the predetermined number of the sub-configurations.

6. The method of claim 4, further comprising:
measuring, by the processor, a channel state information-reference signal (CSI-RS) based on the predetermined number of the sub-configurations.

7. The method of claim 1, further comprising:
transmitting, by the processor, information regarding the number of occupied CSI processing units to the network apparatus.

8. The method of claim 1, wherein said at least one of the sub-configurations corresponds to an antenna port subset which indicates one or more enabled or disabled antenna ports of a plurality of antenna ports of the network apparatus.

9. The method of claim 1, wherein said at least one of the sub-configurations corresponds to one or more power offset values, and the method further comprises:
determining, by the processor, a channel quality indicator (CQI) according to at least one of said one or more power offset values.

10. The method of claim 9, wherein said one or more power offset values comprise a power offset for a physical downlink shared channel (PDSCH) relative to the CSI-RS.

11. A communication apparatus, comprising:
a transceiver which, during operation, wirelessly communicates with at least one network apparatus; and
a processor communicatively coupled to the transceiver such that, during operation, the processor performs operations comprising:
receiving, via the transceiver, a report configuration from the network apparatus, wherein the report configuration contains one or more sub-configurations; and
determining a number of occupied channel state information (CSI) processing units based on a total number of resources corresponding to at least one of the sub-configurations and a scaling number.

12. The communication apparatus of claim 11, wherein the scaling number is greater than 1.

13. The communication apparatus of claim 12, wherein, in determining of the number of occupied CSI processing units, the processor further performs operation comprising:
scaling up the number of occupied CSI processing units with respect to one resource associated with more than one sub-configuration according to the scaling number.

14. The communication apparatus of claim 11, wherein, during operation, the processor further performs operation comprising:
receiving, via the transceiver, an indication to select a predetermined number of the sub-configurations from the network apparatus via a downlink control information (DCI) or a media access control (MAC) control element (MAC-CE), wherein the predetermined number of the sub-configurations is selected from said one or more sub-configurations contained in the report configuration.

15. The communication apparatus of claim 14, wherein the scaling number is set to the predetermined number, and wherein, in determining of the number of occupied CSI processing units, the processor further performs operation comprising:
accumulating the total number of resources corresponding to each of the predetermined number of the sub-configurations.

16. The communication apparatus of claim 14, wherein, during operation, the processor further performs operation comprising:
measuring a channel state information-reference signal (CSI-RS) based on the predetermined number of the sub-configurations.

17. The communication apparatus of claim 11, wherein, during operation, the processor further performs operation comprising:
transmitting, via the transceiver, information regarding the number of occupied CSI processing units to the network apparatus.

18. The communication apparatus of claim 11, wherein said at least one of the sub-configurations corresponds to an antenna port subset which indicates one or more enabled or disabled antenna ports of a plurality of antenna ports of the network apparatus.

19. The communication apparatus of claim 11, wherein said at least one of the sub-configurations corresponds to one or more power offset values, and wherein, during operation, the processor further performs operation comprising:
determining a channel quality indicator (CQI) according to at least one of said one or more power offset values.

20. The communication apparatus of claim 19, wherein said one or more power offset values comprise a power offset for a physical downlink shared channel (PDSCH) relative to the CSI-RS.
